(19) United States
(12) Patent Application Publication
(10) Pub. No.: US 2021/0363799 A1
(43) Pub. Date: Nov. 25, 2021

(54) SELF-LOCKING LOCK DEVICE WITH MULTIPOINT LOCK DRIVE

(71) Applicant: ELDOMAT Innovative Sicherheit GmbH, Berlin (DE)

(72) Inventor: Eberhard BARTHOLDI, Berlin (DE)

(73) Assignee: ELDOMAT Innovative Sicherheit GmbH, Berlin (DE)

(21) Appl. No.: 16/762,017

(22) PCT Filed: Oct. 26, 2018
(86) PCT No.: PCT/EP2018/000491

§ 371 Date: May 6, 2020

(30) Foreign Application Priority Data
Nov. 8, 2017 (EP) 17001831.1

(51) Int. Cl. E05C 9/04

(52) U.S. Cl. CPC E05C 9/042

(57) ABSTRACT

A self-locking lock device has a main latch element which automatically moves into a locking position when the activation is on the closing plate side. The main latch element comprises a drive element for a multipoint lock, which drives at least two additional latch elements of at least one additional latch device at a spatial distance from the main latch element. The drive element is connected to a drive device for at least one additional latch element. The drive device comprises a first drive part and a second drive part. The drive element interacts with the first drive part for a first additional latch element and with the second drive part for a second additional latch element. A movement of the first drive part and of the second drive part is synchronized with a movement of the main latch element.

### TECHNICAL FIELD

The disclosure relates to a self-locking lock device with a trigger element and a main latch element. The disclosure also relates to an additional latch lock device for such a self-locking lock device.

### BACKGROUND

Known from EP 2 956 605 A1 is a self-locking lock device. The main latch element has a pin that engages into a guide slit of a locking bar. The guide slit runs inclined to a direction of movement of the pin when the main latch element is moved into the closed position or into the open position. As a result of the inclined arrangement of the guide slit, the locking bar is moved in the one direction during a closing motion, and in the other direction during an opening motion. In this way, a closing or opening process is initiated on the at least one additional latch element, either directly or indirectly after reversing the direction of movement of the locking bar.

The disadvantage to this known self-locking lock device is that the movement in one direction initiated during a closing process or opening process requires a great deal of force. This is undesirable in an automated process. The lock device should be smooth-running. Furthermore, the additional latch elements must have different designs, since the locking bar moves relative to the latter in respectively different directions during a closing process or during an opening process.

Other self-locking lock devices are generally known from prior art. These are constructed in such a way that the lock device, for example while shutting a door, automatically locks when a trigger element is activated or operated on the closing plate side. Also known from prior art, for example, are multipoint lock drives for locking a door not just via the main latch element that is in direct contact with the lock device, but rather also with at least one other additional latch element at a vertical distance to the main latch element. Such multipoint lock drives are routinely operated via a separate lock mechanism, after the actual main lock has been locked. For this reason, several lock cylinders are then required, which might also necessitate various keys. Handling such a known multipoint lock in conjunction with such a known self-locking lock device is thus inconvenient and complicated for the user.

### SUMMARY

Therefore, an object of the present disclosure is to further develop a self-locking lock device of the kind mentioned at the outset in such a way that it can be used to perform multipoint locking operations much more easily in a single automatic locking process.

The self-locking lock device has a trigger element and a main latch element, which automatically moves into a closing position when the activation of the trigger element is on the closing plate side. The main latch element comprises a drive element for a multipoint lock drive, which drives at least one additional latch lock device with at least one additional latch element at a spatial distance from the main latch element. The drive element interacts with a drive device of at least one additional latch element.

The drive device comprises a first drive part and a second drive part. The drive element interacts with the first drive part for a first additional latch element and with the second drive part for a second additional latch element, and a movement of the first drive part and the second drive part is synchronized with a movement of the main latch element.

The present disclosure is based on the idea of diverting a roughly horizontal movement of a main latch element in the mounted state of a lock device into two vertical movements, so as to thereby control at least two other additional latch elements independently of each other when the locking of the main latch element is automatically triggered.

This is very advantageously achieved by virtue of the fact that two additional latch elements are driven by separate drive parts. The force is divided during a closing motion and during an opening motion. Furthermore, the two additional latch elements can be structurally identical in design.

Another advantage is that the first drive part comprises a first locking bar and the second drive part comprises a second locking bar, and as the main latch element moves in a latching direction, the first locking bar moves in a first direction different than the latching direction, and the second locking bar moves in a direction different from the latching direction and the first direction.

Structurally identical additional latch elements lying remote from the main latch element can be actuated and moved via the first and second diversion of the movement from a latching direction into a first direction different than the latching direction and a direction different than the latching direction and the first direction.

Another advantage to the present disclosure is that the locking bar has a longitudinal axis, and that the guide device is aligned in a main plane inclined to the longitudinal axis.

The inclined arrangement of a guide device makes it possible to induce not just a horizontal movement, but also a vertical movement by the attachment connected with the main latch element when the main latch element is moved between a closed position and an open position in the operating state.

Another advantage to the present disclosure is that the guide device has a slope, wherein the attachment overcomes the slope as the main latch element makes its way out of the closed position into the open position.

This embodiment corresponds to the embodiment described in the following description, and is structurally convenient to realize.

Alternatively, it can also be advantageous for the guide device to comprise a gradient, and for the attachment to overcome the gradient as the main latch element makes its way out of the closed position into the open position. This embodiment could also be structurally convenient under certain circumstances, leaving the expert free to choose between the embodiments depending on application.

Another advantage to the present disclosure is that the attachment is arranged on a lower edge of the main latch element. The position of the attachment as well as the slope determine the path of the respective additional latch element between the closed position and open position.

Another advantage to the present disclosure is that the other piece is arranged on an upper edge of the main latch element. In this case, the attachment and the slope of the guide device also determine the path between the closed position and open position of the respective additional latch element.

Another advantage to the present disclosure is that the other piece is guided out of its movement in the longitudinal slit parallel at two parallel longitudinal edges. This ensures a fixed guide in both directions of the attachment between a closed position and an open position.

It is likewise advantageous that the attachment be a roller, which has a rotational axis perpendicular to the main plane. A roller significantly reduces friction in the guide device.

Another advantage to the present disclosure is that the locking bar is connected with a second additional latch element via a second actuator strap. This makes it possible to establish a multipoint lock on the upper side, for example on the door, in the middle and on the lower side of a door.

Finally, it is also advantageous that a lock device be equipped with a multipoint lock drive according to the present disclosure.

### BRIEF DESCRIPTION OF THE DRAWINGS

An embodiment of the present invention will be described in more detail below based on the drawings.

FIG. 1 is a schematic view of a lock device with multipoint lock drive in a closed position.

FIG. 1a is a schematic view of a first drive device for the lock device from FIG. 1.

FIG. 1b is a schematic view of a second drive device for the lock device from FIG. 1.

FIG. 2 is a schematic view of a lock device with multipoint lock drive in an open position.

FIG. 2a is a schematic view of a first drive device for the lock device from FIG. 2.

FIG. 2b is a schematic view of a second drive device for the lock device from FIG. 2.

FIG. 3 is a schematic view of a lock device with multipoint lock drive from FIG. 1, with open additional latch lock device.

FIG. 4 is a schematic view of a lock device with multipoint lock drive from FIG. 2, with open additional latch lock device.

### DETAILED DESCRIPTION

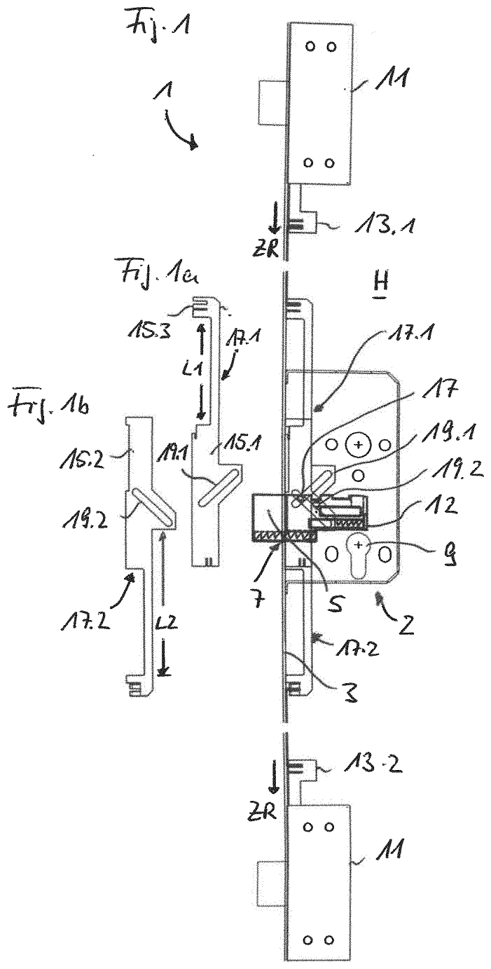

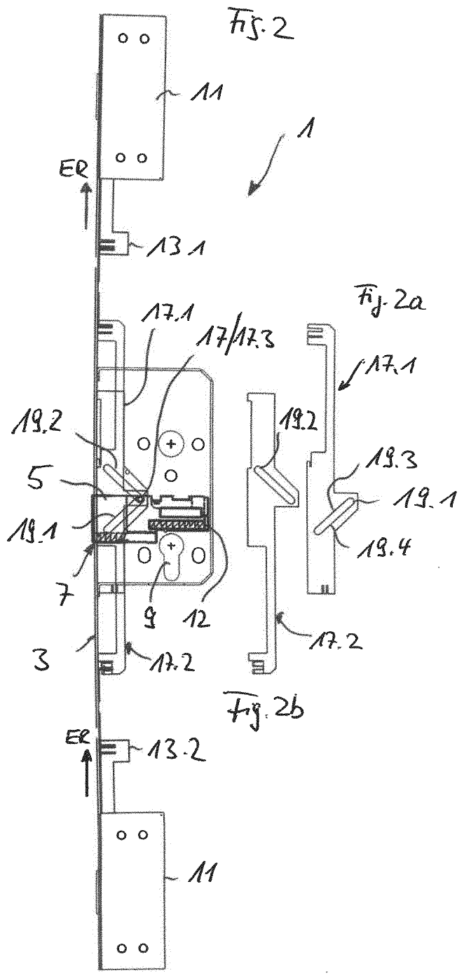

Shown on FIG. 1 is a schematic view from the side of an assembly comprised of a self-locking lock device 1 with a multipoint lock drive 2, which is in a closed position. Shown on FIG. 2 is a schematic view from the side of an assembly comprised of a self-locking lock device 1 with a multipoint lock drive 2, which is in an open position. For example, the lock device 1 is arranged in a door, and is bordered on one side by a cuff rail 3, in which openings 7 are formed, wherein a main latch element 5 can be moved in a latch direction RR through an opening 7 into a closed position (FIG. 1) and back into an open position (FIG. 2). FIG. 1 and FIG. 2 show the path (the latch direction RR) of the main latch element 5 from the closed position into the opening position and vice versa by a respective arrow.

The lock device 1 has a lock cylinder 9, which can be used to manually trigger the lock device, for example to move the main latch element 5 out of the closed position into the open position, or vice versa out of the open position into the closed position. In an alternative not shown, the lock device 1 can also be provided with an electromagnetic door opener, which automatically triggers a closing process and/or an opening process, without the lock cylinder 9 having to be activated.

In an activation step, the main latch element 5 biased by a first compression spring 12 is moved through its opening 7 into the closed position and blocked therein.

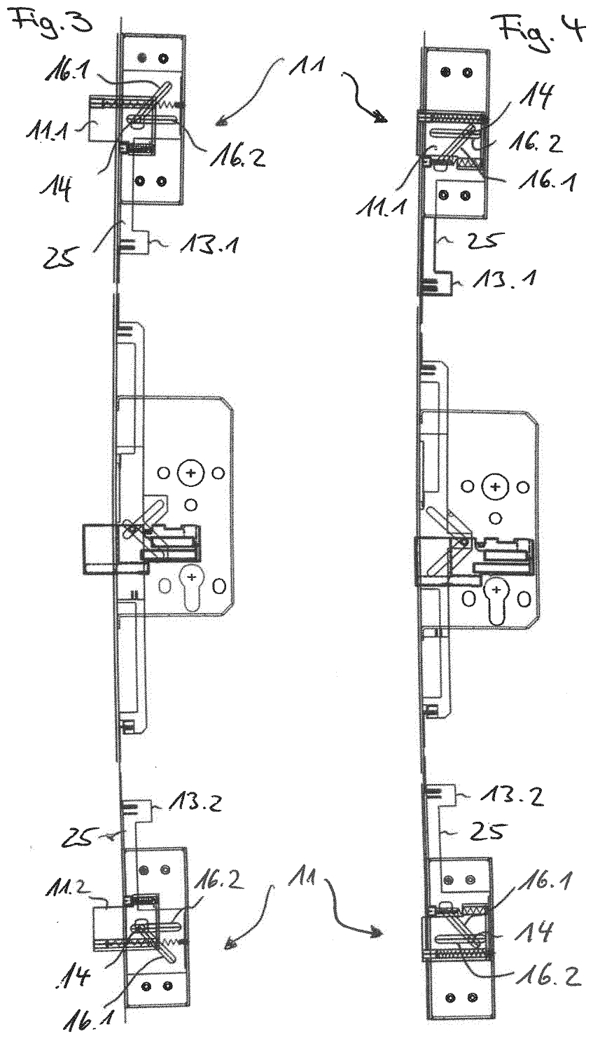

In many situations, it is desired that a door, a window or some other component that locks a wall opening be locked not with a single main latch element 5, but instead that use also be made of at least one other additional lock device 11 with at least one additional latch element 11.1, 11.2. The locking mechanisms for additional latch elements 11.1 and 11.2 can be designed however desired. FIGS. 3 and 4 show a preferred embodiment. The respective additional latch elements 11.1, 11.2 are connected by an actuator strap 13.1, 13.2 with a first locking bar 15.1 or second locking bar 15.2.

The first locking bar 15.1 has a first longitudinal axis L1 and a main plane H that coincides with the leaf level on FIG. 1. The second locking bar 15.2 has a second longitudinal axis L2 and a main plane H that coincides with the leaf level on FIG. 1. The first locking bar 15.1 has a first free end 15.3, into which the actuator strap 13.1 of a first additional latch lock device 11 engages. The second locking bar 15.2 has a second free end 15.4, into which the second actuator strap 13.2 of a second additional latch lock device 11 engages in the present embodiment. The locking bar and actuator strap do not engage into each other directly, but are rather coupled by a connecting rod element (can be up to 40 cm long).

The respective actuator straps can also each be connected with more than a single additional latch element 11.1, 11.2. The first locking bar 15.1 and the second locking bar 15.2 can be moved toward the top and toward the bottom on FIG. 1 and on FIG. 2. The first locking bar 15.1 here moves in a first direction ER and the second locking bar 15.2 here moves in a second direction ZR, wherein the two directions ER and ZR are directed opposite each other in the present embodiment. In a built-in state, such a movement corresponds to a movement in roughly the vertical direction (toward the top or toward the bottom). In the embodiment shown on the figures, the first locking bar 15.1 moves toward the top (ER) during a closing process and toward the bottom (ZR) during an opening process, while the second locking bar 15.2 synchronously moves toward the bottom (ZR) during a closing process and synchronously toward the top (ER) during an opening process.

The main latch element 5 moves behind the main plane transverse to the first and second locking bar 15.1 and 15.2. In the built-in state, the main latch element 5 performs a roughly horizontal latching movement in a latching direction RR, which on the figures means a movement toward the left during a closing process and a movement toward the right during an opening process. A drive element 17 in the form of an attachment or pin is formed on the side of the main latch element 5 facing the observer.

The lock device 1 comprises a drive device for a respective additional latch lock device 11. In the present embodiment, the drive device comprises a first drive part 17.1 with the first locking bar 15.1 and a second drive part 17.2 with the second locking bar 17.2.

FIG. 1a depicts the first drive part 17.1 integrated into the lock device 1 on FIG. 1 separately, i.e., in the closed position. FIG. 1b depicts the second drive part 17.2 integrated into the lock device 1 on FIG. 1 separately, i.e., also in the closed position. FIG. 2a depicts the first drive part 17.1 integrated into the lock device 1 on FIG. 2 separately, i.e., in the open position. FIG. 2b depicts the second drive part 17.2 integrated into the lock device 1 on FIG. 2 separately, i.e., also in the open position.

The first drive part 17.1 comprises the first locking bar 15.1 with the main plane H, and the second drive part 17.2 comprises the second locking bar 15.2 with the main plane H. The two drive parts on FIG. 1 and FIG. 2 are arranged one after the other perpendicular to the leaf level or main plane H, and can slide onto each other during operation. In the depicted embodiment, the two drive parts 17.1 and 17.2 are essentially identically shaped, twisted around a horizontal and shifted toward each other in a vertical, so that the two locking bars 15.1 and 15.2 can at least partially overlap in the built-in state.

The drive element 17 connected with the latch 5 can also be designed as a roller with a rotational axis perpendicular to the main plane H. The drive element 17 engages into a first guide device 19.1 of the first locking bar 15.1 and into a second guide device 19.2 of the second locking bar 15.2. In the present embodiment, the first and the second guide device 19.1 and 19.2 are each a recess and in particular each a longitudinal slit, which runs in the main plane H inclined to the first and second longitudinal axis L1, L2. The angle between the first guide device 19.1 and the first longitudinal axis L1 and the second guide device 19.2 and the second longitudinal axis L2 need not be fixed but lies within a range of approx. 30° to approx. 50°. The angles for the first guide device 19.1 in relation to the first longitudinal axis L1 can differ from the angle for the second guide device 19.2 in relation to the second longitudinal axis L2. The angle is identical in the embodiment shown on the figures.

The alignment of the first guide device 19.1 and second guide device 19.2 in relation to their longitudinal axes L1 and L2 is mirror inverted, however. In the embodiment shown, the slope of the first guide device 19.1 for the drive element 17 is positive during a closing motion (main latch element 5 to the left) and negative during an opening motion (main latch element 5 to the right). By contrast, the slope of the second guide device 19.2 for the drive element 17 is negative during a closing motion (main latch element 5 to the left) and positive during an opening motion (main latch element 5 to the right).

The first guide device 19.1 designed as a longitudinal slit has two parallel first longitudinal edges, and the second guide device 19.2 designed as a longitudinal slit has two parallel second longitudinal edges. The drive element 17 is guided on the respective first longitudinal edges and second longitudinal edges of the longitudinal slits 19.1 and 19.2. In other embodiments, the first guide device 19.1 and second guide device 19.2 can also be configured otherwise, or even entirely differently. It is also possible that the first and second guide device 19.1 and 19.2 be unequally designed and assume various angles in relation to their longitudinal axes.

In the embodiment shown, the first guide device 19.1 for the drive element 17 produces a positive slope on a path out of the depicted closed position into an open position (direction of arrow) (the drive element is retracted, moved downward), which the drive element 17 overcomes on this path, and the second drive device 19.2 for the drive element 17 produces a negative slope on a path out of the depicted closed position into an open position (direction of arrow) (the drive element is retracted, moved upward), which the drive element 17 overcomes on this path. On the path from the closed position into the open position, a relative movement takes place between the drive element 17 and the respective first guide device 19.1 and second guide device 19.2 due to the prescribed guiding paths. The positive and negative slope of the first and second guide device 19.1, 19.2 is overcome based on the horizontal movement (latch direction RR) of the main latch element 5, which forces the respective first locking bar 15.1 to escape downwardly in a vertical direction (direction of arrow), and forces the second locking bar 15.2 to escape upwardly in a vertical direction (direction of arrow). The escaping maneuver is enabled by the guide device 19.1 or 19.2.

FIG. 1a presents a detailed view of the first drive part 17.1 with the longitudinal axis L1. On FIG. 1b, the second drive part 17.2 with the longitudinal axis L2 is shifted laterally to the left in relation to the first drive part 17.1, but in the position where the two drive parts on FIG. 1 lie one over the other and can slide along each other. The first locking bar 15.1 has a first free end 15.3, which is designed to establish a mechanical connection with a first additional latch lock device 11. The first free end 15.3 is much narrower in design in the main plane H than the first locking bar 15.1. The first locking bar 15.1 has approximately double the expansion. In this area, the first guide device 19.1 is designed as a longitudinal slit in the first locking bar 15.1 in the manner already described. The guide device 19.1 is arranged inclined in relation to the first longitudinal axis L1, and in the depicted embodiment extends from the bottom left to the top right. The second locking bar 15.2 has a second free end 15.4 that is designed for establishing a mechanical connection with a second additional latch lock device 11. The second free end 15.4 is likewise a great deal narrower in design than the second locking bar 15.2 in the main plane H. The second locking bar 15.2 has approximately double the expansion. In this area, the second guide device 19.2 is designed as a longitudinal slit in the second locking bar 15.2 in the manner already described. The second guide device 19.2 is arranged inclined in relation to the second longitudinal axis L2, and in the depicted embodiment extends from the top left to bottom right.

FIG. 2a and FIG. 2b show the first drive part 17.1 and the second drive part 17.2 in relation to each other as on FIG. 1a and FIG. 1b, but in the open position, meaning shifted in the longitudinal direction, so that both drive parts overlap a bit more.

FIG. 3 shows the two additional latch lock devices 11 open. Since both additional latch lock devices 11 are structurally identical and only arranged mirror inverted, only the upper additional latch lock device 11 on FIG. 3 will be described in more detail. The upper additional latch lock device 11 has a first additional latch lock element 11.1. The latter is in the closed position on FIG. 3, as is the main latch element 5. The first additional latch lock element 11.1 is connected with an additional latch drive part 25 via an additional latch drive element 14, which is connected with the additional latch lock element 11.1, and a first additional latch guide device 16.1. The actuator strap 13.1 and 15.3 do not engage into each other directly, but are coupled by a connecting rod element (can be up to 40 cm long).

One free end of the additional latch drive part 25 once again has the actuator strap 13.1 for mechanical connection with the first free end 15.3 of the drive part 15.1. The first additional latch guide device 16.1 is also a longitudinal slit, which is aligned according to the first guide device 19.1. In the present embodiment, the angle relative to a vertical is also identical to the corresponding angle of the first guide device 19.1. However, this need not be the case in other embodiments. The angle can be adjusted to the path of the additional latch lock element 11.1. In order for everything to function, the additional latch drive element 14 engages at the top into the first additional latch guide device 16.1, and at the bottom into a horizontal second additional latch guide device 16.2, which is formed in the housing floor.

In this way, the additional latch part 25 moves downwardly, connected to 15.3 and driven by means of a connecting element with drive part 15.1 into the open position shown on FIG. 4.

During a horizontal opening motion, the additional latch drive part 25 must escape downwardly into the open position shown on FIG. 4, and shifts downward together with the first drive part 15.1 until the open position on FIG. 4 has been reached. The additional latch drive element 14 on FIG. 4 is then located in proximity to the other upper end of the first additional latch guide device 16.1. The sequences are reversed during a horizontal closing motion from the open position on FIG. 4 into the closed position on FIG. 3.

In other embodiments, the closing motion or opening motion need not necessarily take place horizontally. The respective lock elements can have other (e.g., greater or less than 90° to the vertical) directions of movement, even ones that differ from each other. However, the principle always remains the same.

### REFERENCE LIST

1 Lock device
2 Multipoint lock drive
3 Cuff rail
5 Main latch element
7 Opening
9 Lock cylinder
11 Additional latch lock device
11.1 First additional lock element
11.2 Second additional lock element
12 Compression spring
13.1 Actuator strap
13.2 Actuator strap
14 Additional latch drive element
15.1 First locking bar
15.2 Second locking bar
15.3 First free end
15.4 Second free end
16.1 First additional latch guide device
16.2 Second additional latch guide device
17 Drive element/attachment
17.1 First drive part
17.2 Second drive part
17.3 Rotational axis, roller
19.1 First guide device
19.2 Second guide device
25 Additional latch drive part
L1 First longitudinal axis
L2 Second longitudinal axis
H Main plane
RR Latch direction
ER First direction
ZR Second direction

1.-14. (canceled)

15. A self-locking lock device (1), comprising:
a main latch element (5) which automatically moves into a closing position upon activation on a closing plate side,
wherein the main latch element (5) comprises a drive element (17) for a multiport lock drive (2) which drives at least two additional latch elements (11.1; 11.2) of at least one additional latch device (11) at a spatial distance from the main latch element (5),
wherein the drive element (17) interacts with a drive device (17.1, 17.2) for at least one additional latch element (11.1; 11.2),
wherein the drive device comprises a first drive part (17.1) and a second drive part (17.2),
wherein the drive element (17) interacts with the first drive part (17.1) for a first additional latch element (11.1) and with the second drive part (17.2) for a second additional latch element (11.2), and
wherein a movement of the first drive part (17.1) and the second drive part (17.2) is synchronized with a movement of the main latch element (5).

16. The self-locking lock device (1) according to claim 15,
wherein the first drive part (17.1) comprises a first locking bar (15.1) and the second drive part (17.2) comprises a second locking bar (15.2), and
wherein as the main latch element (5) moves in a latching direction (RR) the first locking bar (15.1) moves in a first direction (ER) different than the latching direction (RR), and the second locking bar (15.2) moves in a second direction (ZR) different from the latching direction (RR).

17. The self-locking lock device (1) according to claim 16,
wherein the first locking bar (15.1) comprises a first guide device (19.1) and the second locking bar (15.2) comprises a second guide device (19.2), and
wherein the drive element (17) engages into the first guide device (19.1) and into the second guide device (19.2).

18. The self-locking lock device (1) according to claim 17,
wherein the first locking bar (15.1) has a first longitudinal axis (L1) and the first guide device (19.1) is aligned inclined to the first longitudinal axis (L1).

19. The self-locking lock device (1) according to claim 17,
wherein the second locking bar (15.2) has a second longitudinal axis (L2) and the second guide device (19.2) is aligned inclined to the second longitudinal axis (L2).

20. The self-locking lock device (1) according to claim 17,
wherein the first guide device (19.1) has a first slope and the second guide device (19.2) has a second slope, and
wherein the first slope is opposite the second slope.

21. The self-locking lock device (1) according to claim 17,
wherein the first guide device (19.1) and second guide device (19.2) are each designed as a longitudinal slit with two parallel longitudinal edges (19.3, 19.4).

22. The self-locking lock device (1) according to claim 21,
wherein the drive element (17) is guided on both parallel longitudinal edges (19.3, 19.4) as it moves in the longitudinal slit.

23. The self-locking lock device (1) according to claim 16,
wherein the drive element (17) comprises a roller which has a rotational axis (17.3) perpendicular to the main plane (H).

24. The self-locking lock device (1) according to claim 15,
wherein the multipoint lock drive (2) is connected with the at least one additional latch element (11.1) via a first actuator strap (13.1).

25. The self-locking lock device (1) according to claim 24,
wherein the multipoint lock drive (2) is connected with the at least one additional latch element (11.2) via a second actuator strap (13.2).

26. A system, comprising:
the self-locking lock device (1) according to claim 15; and
the at least one additional latch element,
wherein the at least one additional latch element (11.1; 11.2) comprises an additional latch drive element (14) which interacts with an additional latch guide device (16.1) of an additional latch drive part (25) and synchronizes a movement of the additional latch drive part (25) with a movement of the additional latch drive element (14).

27. The system according to claim 26,
wherein the additional latch guide device (16.1; 16.2) forms a slope for the additional latch drive element (14) when the additional latch drive part (25) moves.

28. The system according to claim 26,
wherein the additional latch guide device (16.1; 16.2) is designed as a longitudinal slit with two parallel longitudinal edges, and
wherein the additional latch drive element (21) is guided on both parallel longitudinal edges as it moves in the longitudinal slit.
